(19) United States
(12) Patent Application Publication
(10) Pub. No.: US 2013/0282158 A1
(43) Pub. Date: Oct. 24, 2013

(54) Device and Method for Filtering Supply Network Failures Out of an Electrode Signal in a Metallurgical Electric Remelting Process

(71) Applicants: Ralf Oehler, Darmstadt (DE); Harald Scholz, Rodenbach (DE); Frank-Werner Hoffmann, Budingen (DE)

(72) Inventors: Ralf Oehler, Darmstadt (DE); Harald Scholz, Rodenbach (DE); Frank-Werner Hoffmann, Budingen (DE)

(21) Appl. No.: 13/880,573

(22) PCT Filed: Oct. 6, 2011
(86) PCT No.: PCT/EP11/67485

§ 371 Date: Jul. 2, 2013

(30) Foreign Application Priority Data
Oct. 21, 2010 (DE) 10 2010 042 781.0

(51) Int. Cl. G05B 23/02

(52) U.S. Cl. CPC G05B 23/0205
USPC 700/108

(57) ABSTRACT

The invention relates to a method and device (40) for filtering supply network failures (84) out of an electrode signal (82) in a metallurgical electric remelting process, in particular for the electrode gap closed-loop control of a system for closed-loop control of an electrode gap (48) of a melting furnace (10). For this purpose, said device also comprises at least one electrode sensor device (44) for measuring an electrode signal (82), in particular electrode current and/or electrode voltage of the electrode (30), a network sensor device (46) for measuring a network signal, in particular network current and/or network voltage, and a filter device (50) for filtering network failures (84) of the network signal out of the electrode signal (82), such that an electrode signal (80) with no network failures can be emitted.

The present invention relates to a method and device for filtering supply network failures out of an electrode signal in a metallurgical electric remelting process. In particular, the invention relates to a method and device for improved electrode gap closed-loop control of a system for closed-loop control of an electrode gap in a melting furnace in the context of a metallurgical electric remelting process, such as vacuum arc remelting processes or electro-slag remelting processes.

In the context of a metallurgical electric remelting process, for instance an electro-slag remelting process or a vacuum arc remelting process, high currents with low voltages are used for remelting an electrode in a furnace chamber, wherein, by means of a current transfer from the end of the electrode toward the melt material, the electrode material is melted off completely and is converted into the liquid melt material, which possesses high purity characteristics.

The electric remelting process is a metallurgical process for producing steels of highest purity, which solidify after having been straightened and have a flawless structure. With this process, a rigid steel block is dipped into a slag bath, wherein the block has the function of an electrode and is melted off. When passing through the slag, sulfur and non-metallurgical inclusions are absorbed by the slag and subsequently precipitated. The steel solidifies under the slag. Steels produced in this way have an improved technological property.

The vacuum arc melting process is a melting process for producing high-quality melt materials which have improved chemical and mechanical properties and homogeneities and meet highest quality requirements. For this purpose, an electrode is melted off in a vacuum or in a low pressure atmosphere in a cooled furnace chamber by means of an arc, wherein the liquid melt material cumulates at the furnace chamber end and a high-precision closed-loop control with respect to a gap as equal as possible between the lower edge of the electrode melting-off and the rising surface of the liquid melt material has to be carried out.

Such electrode-based metallurgical remelting processes are usually carried out in a harsh electrical environment, in which high-current consumers are present and in which corresponding failures occur in the supply network, such as voltage drops, fluctuating voltage levels and high-frequency switching impulses etc. For instance, a plurality of lighting and heating devices or drive motors are actuated by means of output controllers and/or inverted rectifiers, such that high-frequency switching impulses of the electric drives in the supply network can be detected. These failures even affect the direct current or alternating current supply voltage for the remelting process and can be detected there.

Normally, the occurring network failures are periodic, that is they occur corresponding to the frequency or a multiple of the frequency of the supply network, for instance 50 or 60 Hz. Thus, with a majority of said network failures, phase relationships to the network period can be established. Said failures can be fed into the electric system of the remelting process when converted as a supply voltage for the remelting process, and have negative effects there. In modern remelting furnaces, the closed-loop control of the electrode gap, that is the closed-loop control of the gap of the electrode from the surface of the melt material, which is mainly responsible for the quality of the melt material, is based on an indirect measuring of the voltage or of the currents from the electrode toward the melt material, wherein occurring short-circuits are detected and the electrode gap can be subjected to closed-loop control on the basis of these short-circuits. A constant occurrence of uniform droplet short-circuits indicates a constant electrode gap. Thus, there are parallel further developments, for instance, which take into account an improved electrode closed-loop control by means of a high-precision detection of electrode short-circuits in narrow voltage ranges or short time intervals. In these cases, network failures, which affect the supply currents, affect the closed-loop control of the electrode gap in a particularly negative way.

It is the task of the present invention to provide a device and method, by means of which supply network failures in the context of a metallurgical electric remelting process can be filtered out, such that in particular a high-precision closed-loop control of the electrode gap, which is based on the detection of voltage or current drops of the electrode current, can be carried out.

This task is solved by a device and method according to the independent claims. Advantageous further embodiments are the subject matter of the dependent claims.

According to the invention, a device for filtering supply network failures out of an electrode signal in a metallurgical electric remelting process is provided, which can in particular be used for the electrode gap closed-loop control of a system for closed-loop control of an electrode gap of a melting furnace. The device comprises at least one electrode sensor device for measuring an electrode signal, in particular electrode current and/or electrode voltage of the electrode, a network sensor device for measuring a network signal, in particular network current and/or network voltage, and a filter device for filtering network failures of the network signal out of the electrode signal, such that an electrode signal with no network failures can be emitted.

By means of the device, an electrical electrode signal, for instance the electrode voltage, or the flowing electrode current, which is used for remelting the electrode, is measured and data of a network sensor device are recorded, from which, for instance, the network current, the network voltage or the network frequency can be determined. Furthermore, the invention comprises a filter device which is able to filter network failures of the network signal out of the electrode signal, such that a corrected electrode signal can be provided, with which, for instance, periodically occurring network failures are suppressed. By a comparison of the electrode signal and the network signal, failures injected into the network can be identified in the electrode signal and be eliminated, such that the electrode signal only contains information on the remelting process without any failure effects of surrounding electrical installations. An electrode signal filtered in such a manner makes a high-precision closed-loop control possible of, for instance, the electrode gap between the electrode and the liquid surface of the melt material, such that an increased quality of the remelt material can be achieved.

According to an advantageous further embodiment, the filter device can comprise at least one frequency filter unit for frequency filtering of relevant signal ranges of the electrode signal and/or the network signal. For instance, the filter device can comprise conventional filter elements, such as capacitances, inductors, ideal resistors, or the like, or an active filter circuit comprising circuit components such as transistors, thyristors or ICs, which can filter periodically occurring network failures out of the electrode signal. The frequency filter unit can, however, also comprise a complex signal processing unit which analyses the electrode signal or the network signal in order to be able to analogously or digitally filter correlating signal failures out of the electrode signal.

According to another advantageous further embodiment, the filter device can comprise at least one adaptation unit for adapting the network signal and/or the electrode signal to each other and a subtraction unit for subtracting the adapted signals from each other. In the case of a remelting process based on alternating current, for instance, a scaling of the network signal or the electrode signal can lead to both signals being adaptable to each other amplitude-wise, such that a simple subtraction of the signals from each other only results in the failures in the electrode signal caused by the remelting process, such that, on the basis of this short-circuit information, an electrode closed-loop control can be carried out. In the case of a direct current voltage remelting process, for instance, the network signal can be rectified and be adapted to the electrode signal in the amplitude, such that, in this case, a subtraction can also lead to the filtering of the network-induced errors.

According to an advantageous further embodiment, the filter device can comprise a phase detection unit for detecting a network phase value and a storage unit for storing time-discrete, phase-related samples of the electrode signal and/or the network signal in a plurality of phase storage locations. Thus, the filter device can take samples of the electrode signal and/or the network signal at discrete moments at storage locations, which will be referred to as phase storage locations in the following, corresponding to a determined network phase value, which can be determined by means of a phase detection unit, for instance on the basis of a zero point of the network phase, and thus, can store a discrete representation of the successive samples in successive phase moments, that is in sample moments of a network period. In this way, a sampled phase of the network signal and/or the electrode signal can be analyzed, wherein, after repeated samplings, noticeable network failures can be filtered out.

Building on the previous embodiment, furthermore, a phase detection unit can advantageously comprise a network phase identification means, in particular a PLL phase identification means. The phase detection unit has the task to identify the phase, that is the moment of a zero point of a period of the network voltage. For this purpose, it is convenient to use a network phase identification means, for instance a phase identification means known from a phase connection control or a PLL phase identification means (phase-locked loop). A phase servo loop, which is referred to as a phase-locked loop, is an electronic circuit assembly which can detect the phase position and, in this connection, the frequency of an oscillation, wherein a phase deviation as small as possible between an external network signal and the generated signal can be achieved. It serves to identify and monitor the phase of the network, even if the network suffers from heavy network failures, and can reliably provide exact phase information. It can serve to associate, with high precision, samples within a network period with individual phase storage locations.

If sampled electrode or network signals are to be phase-relatedly stored, this can be realized in any possible way in principle. Starting from the preceding embodiments, in an advantageous further embodiment, the phase detection unit can comprise a multiplexer and a demultiplexer unit, wherein the multiplexer unit is able to attribute a sample of the electrode signal and/or the network signal to a phase storage location and the demultiplexer unit is able to read out a sample of a phase storage location in correct phase relationship. In this case, it is proposed, on the basis of the detected phase of the phase detection unit, to actuate a multiplexer which, in each case, connects to a predetermined phase storage location, to which it can attribute a sample of a particular phase moment, wherein the multiplexer is able to advance from one phase storage location to another as a function of the detected phase. Correspondingly, by means of a demultiplexer, the contents of the phase storage locations are read corresponding to the detected phase and their values can be read out continuously, in order to reconstruct the stored signal. Thus, the combination of a phase detection unit, a multiplexer and a demultiplexer unit serves to store sampled values in so-called phase storage locations, which can store the temporal development of the electrode signal or of the network signal over a network period. Thus, an incremental representation, grouped according to phase values of the development of the signal over a network period, is available. The individual phase gaps between the values of the phase storage locations can be selected to be constant, but they can also be variable. Thus, it can be convenient to select smaller phase gaps in phase ranges, in which many variations or failure impulses occur, than in ranges, in which few variations occur between the individual phase points.

Building on the previous embodiments, in an advantageous manner, the filter device can furthermore comprise a periodicity analysis unit for analyzing periodic network failures in the electrode signal, wherein the periodicity analysis unit is able to read out, change and store phase-related samples stored in the phase storage locations of the storage unit. Here, the periodicity analysis unit has access to the individual phase storage locations and can read out phase-related samples therein, and compare said samples with each other, and observe the development of the values in the individual phase storage locations, for instance over several periods, and identify whether in particular phase storage locations, periodic signal fractions are present. These can be identified as periodic network failures and be distinguished from the statistically distributed short-circuit failures of the electrode signal. Such phase-constant failures can be deducted by the periodicity analysis unit in the phase storage locations, such that network failures can be removed from the recorded electrode signals.

Building on the previous embodiments, the periodicity analysis unit is able to adjustably average or smooth an attributable sample of a phase storage location with previously stored, historical samples of said phase storage location and/or to adjustably weight said sample with samples of neighboring phase storage locations with respect to the time. In this regard, it is conceivable that each phase storage location comprises several registers which include the historical samples of preceding network periods. The periodicity analysis unit can compare the currently stored samples of each phase with preceding samples of the same phase moment or with the current and historical values of neighboring phase storage locations. Here, it is able to perform an averaging, smoothing and analyzing with respect to neighbors in time or network period history.

The periodicity analysis unit can identify ranges of high amplitude variations in particular phase ranges or time intervals in a simple manner. Here, it is conceivable and advantageous that the periodicity analysis unit is able to adaptably control a switching phase interval of the multiplexer and the demultiplexer unit, in order to generate an adaptive time fence. For instance, the periodicity analysis unit can define large switching phase intervals in phase ranges in which few failures occur, and determine small phase time intervals in phase ranges in which high-frequency failures occur, such that the multiplexer and the demultiplexer unit cannot perform an equidistant sampling, but rather an adaptably adjustable sampling of the occurring amplitude values over the phase time intervals. Thus, an adaptably adjustable filtering of failures in relevant frequency ranges can be achieved. For instance, 1000 to 5000 phase storage locations for a network period of 50 or 60 Hz can be created. This corresponds to a phase time interval of 16 to 20 μs in the case of 1000 storage locations. In this way, network failures in the range until 25 kHz could be taken into account. Correspondingly, with a larger number of phase storage locations, network failures with higher frequencies can be taken into account. Usually, motor control inverted rectifiers operate at sample frequencies of 16 kHz, output controllers cause significant failure impulses up until the range of 20 kHz or higher, such that a number of phase storage locations of 1000 to 20000 is convenient.

In a side aspect, the invention provides a method for filtering supply network failures out of an electrode signal in a metallurgical remelting process, which can be used in particular for the closed-loop control of an electrode gap, and preferably using a device according to one of the preceding claims. In this context, an electrode signal, in particular electrode current and/or electrode voltage of the electrode, and a network signal, in particular network current and/or network voltage or network frequency, are measured, and network failures of the network signal are filtered out of the electrode signal, such that an electrode signal with no network failures can be emitted. The filtering method takes into account the development of the electrode signal in itself as well as at least one phase relationship, which can be gained from the network voltage. On the basis of the measured network voltage, failures which have reached the electrode signal from the supply network can be eliminated from the electrode signal. For instance, a phase relationship which can be deduced from the network signal can serve for this purpose, in order to remove phase-correlated network failures from the electrode signal.

According to an advantageous further embodiment, the electrode signal and the network signal can be adapted to each other and be subtracted from each other. For instance, the network signal can be transformed to the size of the electrode signal in a scaled manner in the case of remelting processes based on alternating current voltages, and be subtracted from it, wherein all corresponding network signal failures in the electrode signal can be eliminated. An electrode signal remains, in which only failures influenced by the remelting process are contained. In the case of a remelting process based on direct current voltages, the network signal can be rectified, wherein in the rectified network signal, network failures are also represented and these can be deducted from the rectified electrode signal in a scaled manner, in order to be able to analyze only failures caused by the remelting process.

Corresponding to an advantageous further embodiment of the method, on the basis of the network signal, a network phase can be identified, and phase-related samples of the electrode signal can be stored, such that, on the basis of the electrode signal samples, periodic network failures can be identified and be deducted from the electrode signal. Thus, this procedure proposes to store phase-related samples of the electrode signal and to analyze their phase relationship with respect to the network period, wherein network phase correlated failure signal fractions can be filtered out of the electrode signal samples.

Corresponding to an advantageous further embodiment, the samples can be averaged with preceding samples and/or be adjustably weighted with phase-neighboring samples, in particular be weighted amplitude-, phase- and/or frequency-dependently. By means of the phase sampling, with small phase differences, the samples can only be associated with the exact phase in an imprecise manner. Thus, an improvement of the filtering effect can be achieved in that neighboring phase values and also preceding network phase values are taken into account and, when analyzing the phase relationships, are taken into account in a weighted or smoothed form.

An additional or alternative filtering option can be to locate such phase locations, at which failures with phase fluctuations occur, for instance by examining the immediate phase vicinity and to filter the filtered signal through another filter, for instance a low-pass filter with an adapted trap frequency, in these moments. The adaptation results from the type of the failure at this phase location.

For instance, a thyristor controller turns a heater on and off quickly and irregularly fluctuatingly at phase 40+/−1-2° over a longer period. In the range of 38 to 42°, thus a load slope occurs. This slope has, for instance, a steepness which corresponds to, for instance, a spectrum of 10 kHz. The filter will not be able to effectively filter out the failures in the range of 38 to 42°, since in this range, the failure varies phase-wise. However, a downstream low-pass with a trap frequency of <10 kHz, which is only switched on in the time interval in which the phase position is between 38 and 42°, can suppress this high-frequency phase-blurred failure. So to speak, this low-pass would “retouch” the electrode signal, such that only those parts are not suppressed, which are surely not overlapped by failures. Thus, a frequency filter which can be selectively switched on only in particular, small phase time intervals, in particular smaller than 10°, preferably smaller than 5°, in particular a low-pass filter, can efficiently suppress periodically occurring failures, without affecting statistically uncorrelated short-circuit information. Furthermore, the failure signals occurring in this period can be ignored when examining the closed-loop control of the electrode gap. For this purpose, it can be advantageous to transmit the information on the localization of the signal fractions to be ignored to the device for closed-loop control, for instance a droplet detector.

Corresponding to an advantageous further embodiment, the phase interval of the samples can be adapted corresponding to occurring signal changes. The phase interval, that is the time gap of two samples within a network period, can be adapted, for instance to the variation of the network voltage or the variation of the electrode signal, such that, with high-frequency failures in the electrode signal or the network signal, a finer sampling, that is a shorter phase interval than in ranges with few failures, can be fixed. Thus, with a finite resolution of the phase samples, an improved precision of the filtering effect can be achieved. The adaptation can also be influenced by setting a desired filter precision or a desired filter range.

According to an advantageous further embodiment, the number of the samples can be variably adapted in particular to the type and extent of the network failure and/or the phase of the remelting process. For instance, in the initial remelting phase, in which only few electrode failures occur or the network failures only play a subordinate role, a relatively coarse resolution of the network filter can be selected, and in the range of a highly-sensitive remelting phase, a resolution as high as possible with a large number of phase storage locations and a correspondingly high computational cost can be used, in order to be able to effectively filter out network failures, in particular in ranges of, for instance, high or low droplet short-circuit rates. In this way, a failure filter can be adaptively used corresponding to a desired filter precision.

In principle, the device, which is based on a phase detection, can be compared to a fading fluorescent monitor, for instance an oscilloscope, with respect to its mode of action. Such a method is referred to as Digital Persistence Mode in modern digital oscilloscopes and serves to analyze complex oscillation processes: within a network period, for instance 50 Hz, that is 20 ms or 60 Hz, that is 16.66 ms, electrode signal data, for instance electrode voltage or electrode current, are recorded and stored in discrete phase storage locations. After multiple repeated network periods, by means of averaging and comparing operations, only those values constantly remain in the phase storage locations which periodically have a fixed phase relationship to the network period, for instance an overtone. One-time failures “fade”. This can be compared with an electrode beam which skims over a fluorescent monitor of an oscilloscope and luminesces, wherein the luminescing areas fade over time, unless these signals do not periodically continue to occur. Such periodically occurring signals with a fixed phase relationship can be interpreted as network failures and be deducted from the originally recorded electrode signal, such that an electrode signal free of failures exists. In this sense, the averaging between neighboring phase storage locations or preceding phase storage locations can be interpreted as a non-permanent “phase memory”, such that signal fractions remain which have a phase relationship and are repeated within one network period and occur over several network periods, wherein stochastic failures, which, for instance, can be explained by droplet short-circuits, are not represented in the recorded signal of the phase storage. A subtraction of the “luminescing” signal represented in the storage unit from the currently recorded electrode signal leads to a suppression of signal fractions which have a fixed phase relationship to the network period and thus are to be interpreted as network failures.

Further advantages of the present invention result from the present drawing description. In the drawing, embodiments of the invention are illustrated. The drawing, the description and the claims comprise many features in combination. The person skilled in the art will expediently also put the individual features together for further reasonable combinations.

In the drawings:

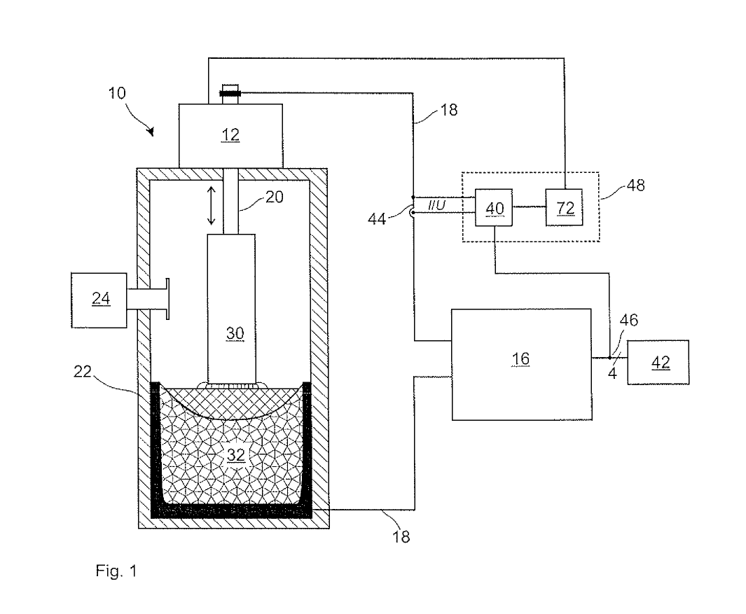

FIG. 1 schematically shows a metallurgical electric remelting device with an electric-based electrode closed-loop control;

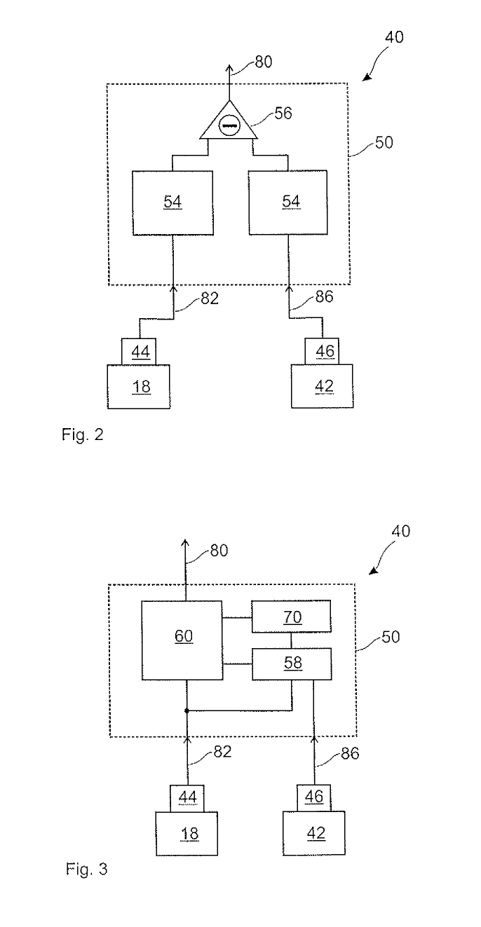

FIG. 2 shows a first embodiment of a filter device;

FIG. 3 schematically shows a second embodiment of a filter device;

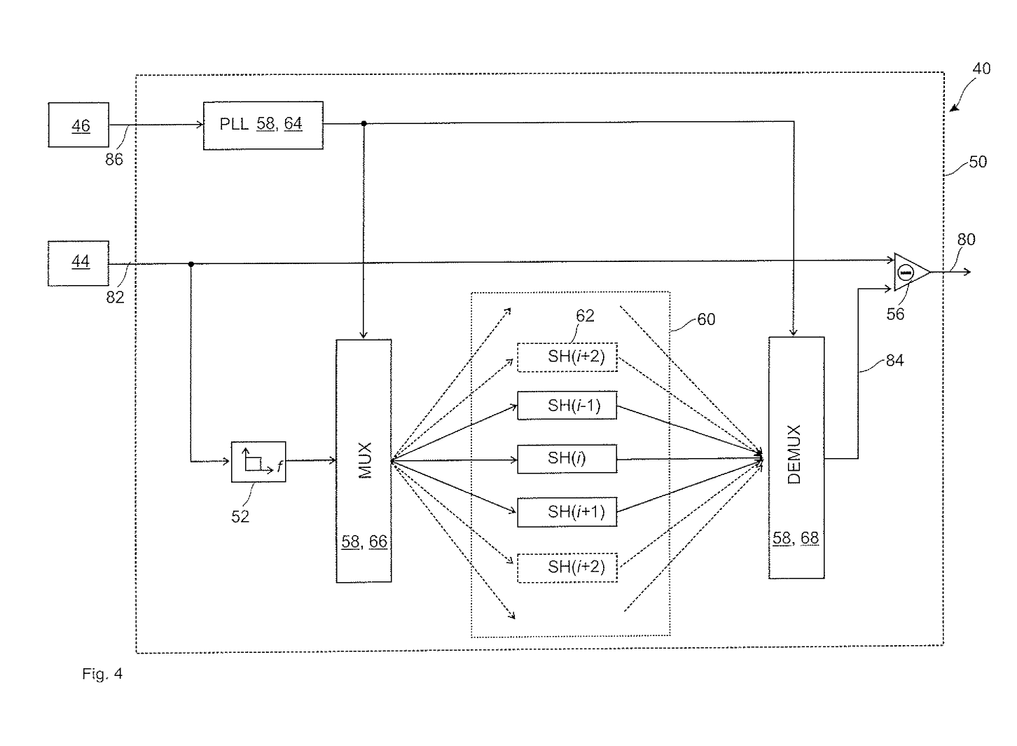

FIG. 4 shows a further embodiment of a filter device;

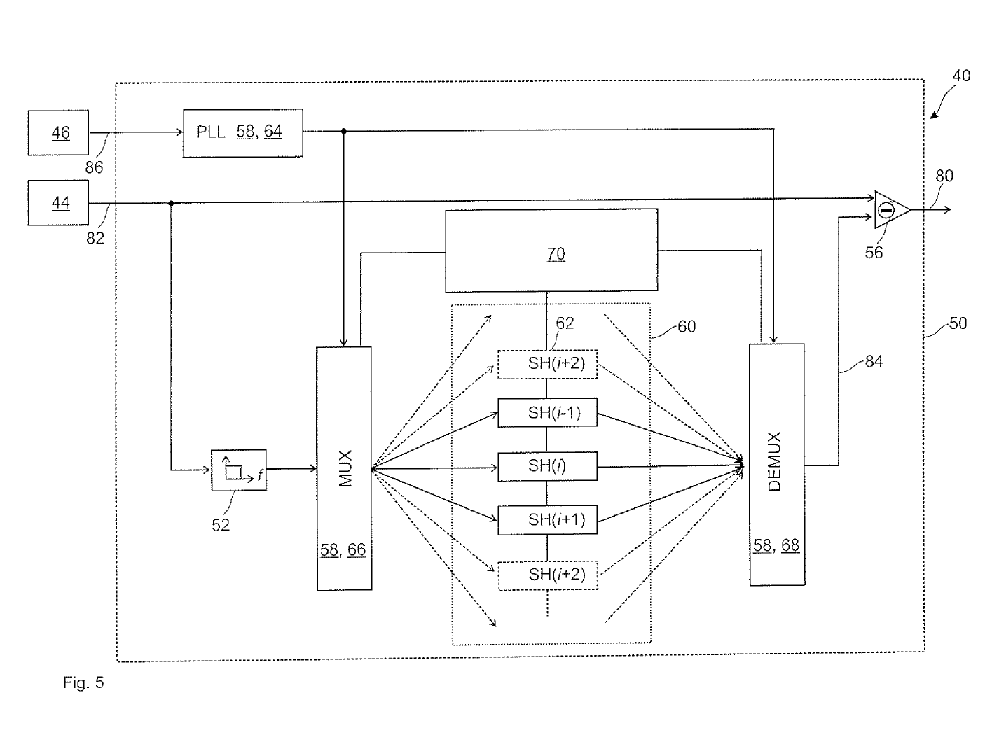

FIG. 5 shows a further embodiment of a filter device;

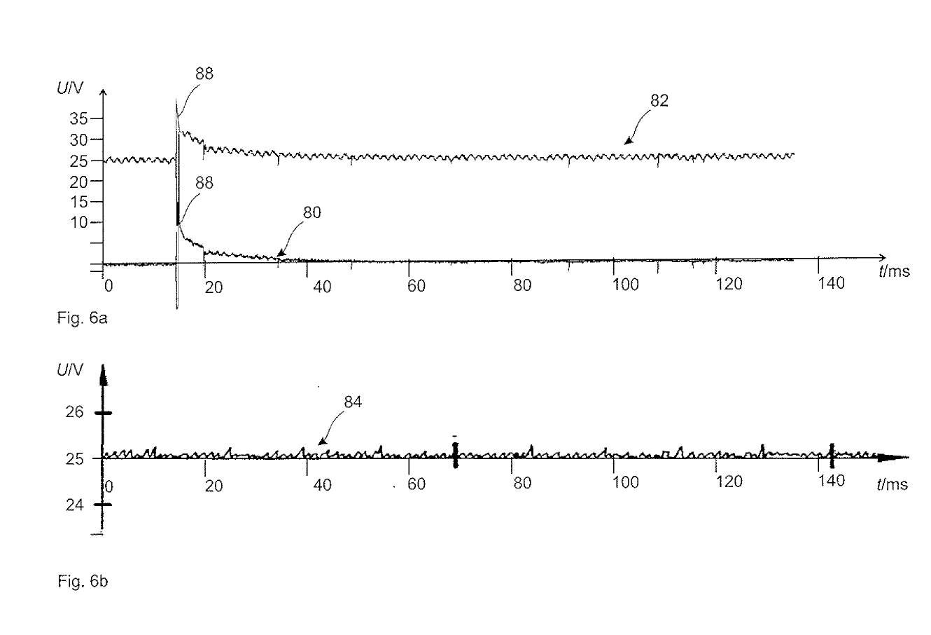

FIG. 6 shows an unfiltered, filtered electrode signal as well as a network failure signal.

In the figures, equal or similar components have the same reference numerals.

FIG. 1 schematically shows a metallurgical electric remelting device, in this case a vacuum electrode remelting device, with which, in an electric melting furnace 10, the gap of an electrode 30 from the liquid surface of a melt material 32 is adjusted by means of an electrode drive device 12. The electrode drive device 12 vertically moves an electrode feed bar 20, at which an electrode 30 is attached and which adjusts the gap of the lower edge of the electrode from the liquid surface of a melt material 32. The melt material 32 is included in a water-cooled vacuum furnace chamber 22, wherein a low pressure or a vacuum is generated by means of a vacuum generation device 24. Due to the fact that a direct electrode gap measurement is difficult to carry out, an indirect measurement is carried out by examining an electrode signal, that is the electrode current, which is supplied through power supply lines 18 to the electrode and the melt material 32, or the applied electrode voltage. For this purpose, an electrode sensor device 44, for instance a current and/or a voltage measuring device, is connected to the power supply lines 18 of the electrode 30, whose signals are tapped by a system for closed-loop control of an electrode gap 48. The electrode voltage or the electrode current is provided by a remelting power supply device 16. The latter receives the supply voltage through a supply network 42, for instance as a three-phase alternating current or by interposing a transformer from a high-voltage network. Due to the high-current consumers installed in immediate electrical vicinity, the obtained electrical energy of the supply network 42 can be overlapped with failures. Said failures can, for instance, be voltage drops, high-frequency oscillations and impulses due to phase angle controls, for instance by electric motor drives or output controllers such as thyristor-based dimmer circuits, periodic switching operations of lightings, heaters, machines and the like. Said failures are injected up into the electrode signal through the power supply device 16, on the one hand, they affect the remelting process disadvantageously, and on the other hand, they impede a direct measurement of relevant parameters of the electrode signal, which can be used, for instance, for a gap closed-loop control. They can be, for instance, droplet short-circuit rates, the stability of the applied direct current voltage or the like. In order to filter said negative network failure signals out of the electrode signal, the system for closed-loop control of an electrode gap 48 comprises a network failure filter device 40 as well as a device for closed-loop control of an electrode gap 72, which is able to directly actuate the electrode drive device 12 in order to adjust an optimal electrode gap. The device for closed-loop control of the electrode gap 72 performs a closed-loop control of the gap on the basis of the electrode signal which is free of network failures.

FIG. 2 shows a first embodiment of a network failure filter device 40. The network failure filter device 40 illustrated in FIG. 2 is based on a scaling of the electrode signal and/or the network signal, such that both signals can be adapted to each other and subtracted from each other. For this purpose, the network failure filter device 40 comprises an electrode sensor device 44, for instance voltage or current meters, which taps an electrode signal of the power supply line 18 of the remelting electrode. The electrode signal 82 of the electrode sensor device 44 is transmitted to a signal adaptation unit 54. In parallel, a network sensor device 46 records a network signal 86 of a supply network 42 and also transmits it to a signal adaptation unit 54. The two signal adaptation units adapt the electrode signal 82 or the network signal 86 in such a manner that the two signals can be subtracted from each other in a subtraction unit 56, such that only those information fractions remain in the electrode signal 82 which are not present in the network signal 86. Thus, network failures can be removed from the electrode signal 82 and the latter can be emitted as an electrode signal 80 with no network failures. The signal adaptation unit 54 can comprise, for instance, transformers, rectifiers, repeaters, attenuators or the like. In particular, with an electrode remelting process based on direct current voltage, a rectifier or an inverted rectifier can be included, as well as analogous or digital component parts, which can refine, for instance, the electrode signal or the network signal 82, 86 in a digital form and subtract them from each other by means of a digital processing.

FIG. 3 schematically shows another embodiment of a network failure filter device 40, in which, by means of an electrode sensor device 44 from the power supply lines 18 of the remelting electrode, an electrode signal 82 and, from the supply network 42 by means of a network sensor device 46, a network signal 86 is tapped and supplied to a filter device 50. Within the filter device 50, the network signal 86 is received by a phase detection unit 58, wherein a network period, for instance 50 Hz or 60 Hz, (period duration 20 ms or 16.66 ms) is identified. In this way, the network phase of the currently identified network signal is known and network phase based amplitude comparisons can be carried out. The electrode and the network signal 82, 86 are transmitted to the phase detection unit 58 and passed on to a periodicity analysis unit 70. Furthermore, the electrode signal 82 is transmitted to a storage unit 60, in which a phase-correlated storage of the sampled electrode signal fractions is carried out. Thus, comparable to an electrode beam skimming over a luminescent monitor surface, signals of the electrode signals are stored in phase storage locations of the storage unit 60, and, by means of the periodicity analysis unit 70, can be analyzed with respect to the occurrence of a network period-correlated failure. The periodicity analysis unit 70 can take into account, on the one hand, the current phase time as well as signals of preceding and neighboring phase locations, in order to identify periodically occurring failure signal fractions in the electrode signal samples stored in the phase storage locations of the storage unit 60. Subsequently, the failure signal fractions which were identified in the storage unit 60 can be deducted from the recorded electrode signal 82, in order to emit an electrode signal 80 with no network failures.

Building on the embodiment illustrated in FIG. 3, FIG. 4 shows a detailed illustration of an embodiment of a network failure filter device 40 which is based on a phase-related detection of network failures. The network failure filter device 40 of the FIG. 4 comprises a network sensor device 46 for recording a network signal 86 and an electrode sensor device 44 for recording an electrode signal 82. A phase detection unit 58, which comprises, for instance, a network phase identification means 64, in particular a PLL, extracts a network period duration as well as information of the respectively applied network phase from the network signal 86, for instance in the form of a time offset Δt or an angle φ which extends from 0 to 360° and covers a network period of, for instance, 50 Hz (20 ms) or 60 Hz (16.66 ms). The network signal 86 is only evaluated for extracting the network phase information and is not required for the further signal processing, since said processing exclusively concentrates on the electrode signal and performs an identification of phase-correlated failure signals starting from the electrode signal and the knowledge of the network phase. The electrode signal 82 is transmitted, on the one hand, to a subtraction unit 56, and on the other hand, after a low-pass filtering, via a frequency filter unit 52 to a multiplexer unit 66 which performs an attribution of the sampled electrode signal to individual phase storage locations 62 of a storage unit 60, as a function of the identified phase. Thus, sampled electrode signal values are stored in a finite number of phase storage locations, wherein a phase relationship is known for each sample. The phase storage locations 62 can be, for instance, sample-and-hold elements, which can perform a sampling of instantaneous values and a storage of the sample. In this regard, in particular the phase storage location 62 can be a “forgetful” phase storage location, which, for instance as capacitor-resistance configurations (RC member), comparable to a low-pass, “forget” the stored values again after a short, adjustable time. Thus, for instance the electrode signals recorded within one period can already be deleted completely from the phase storage locations after two to three further network periods. On the opposite side of the storage unit 60, a demultiplexer unit 68 is located which can read out the stored values of the phase storage locations 62 in correct phase relationship and can reconstruct the stored electrode signal. The reconstructed, sampled electrode signal is deducted from the actual electrode signal 82 in a subtraction unit 58, whereby an electrode signal 80 free of direct current voltage and network failures can be emitted. A feature of the phase storage location 62 is essential for the quality of the failure signal suppression: it forgets stored values after one or more network periods or makes them smaller. This can be interpreted comparable to the luminescing of an electrode beam which skims over a fluorescent surface. If signal fractions are recorded only once, they luminesce almost not at all or only for a short time. A periodic occurrence of a failure signal causes a “luminescing” or a permanent storage within the phase storage location 62, such that it can be reliably removed from the electrode signal 82. Thus, the subtraction unit 56 removes in particular those signal fractions from the electrode signal 82 which occur repeatedly and frequently with a specific phase correlation to the network period. In this way, with knowing the type of the network failure and based on the phase-correlated storage capacity of the phase storage locations 62, a suppression of phase-related signal failures in the electrode signal 82 can be performed. Preferably, the phase storage locations 62 are designed in the form of a low-pass, that is an RC circuit or equivalent to an LR circuit.

In a similar way to the embodiment illustrated in FIG. 4, FIG. 5 shows another embodiment of a network failure filter device 40 which essentially comprises the same elements as the embodiment illustrated in FIG. 4. The “forgetfulness” of the phase storage locations 62 is monitored and made possible by a periodicity analysis unit 70 which not only has access to the multiplexer unit 66, but also to the demultiplexer unit 68, and which can control the sampling of the electrode signal as a function of the type of the signal. Thus, for instance in phase ranges in which a high variation occurs, smaller phase intervals can be selected, in order to achieve an improved resolution of the sampled electrode signal. Correspondingly, the demultiplexer unit has to make an improved sampling of the electrode signal possible in these phase locations for reconstructing a periodic network failure signal. Furthermore, the periodicity analysis unit 70 can have access to the individual phase storage locations 62 of the storage unit 60, in order to compare, average or smooth, for instance, the samples in the individual sample-and-hold elements or phase storage locations to neighboring samples, and to compare, for instance storage values of preceding sample periods to current samples. Thus, an averaging via phase values temporally neighboring in the phase as well as historically preceding can be carried out throughout a period, in order to take into account, for instance, phase drifts of failure signals. Thus, the periodicity analysis unit 70 can, on the one hand, perform a “gradual fading” of samples which do not occur regularly within a phase storage location 62, and on the other hand, an analysis of preceding values as well as take into account neighboring phase storage values. The unit 70 can take into account preceding phase values or neighboring phase values, for instance by means of a low-pass or by means of averaging and attenuation functions, and can reconstruct a local blur of failure signal values. In phase ranges, in which no particular network failures were detected in the past or in which no noticeable, periodically occurring failure fractions in the electrode signal 82 could be determined, a large phase sampling interval can be used for actuating the multiplexer and the demultiplexer unit 66, 68. In ranges, in which high failure intensities occur, for instance in periodic ranges which indicate a multiple of the period duration of the network signal 86, small phase sampling steps, that is a high resolution of the samples electrode signal, can be set in the storage unit 60. Furthermore, depending on the remelting phase, an expensive analysis of network failure signals or a coarse filtering can be performed.

Lastly, FIG. 6 shows the course of an electrode signal 82 susceptible to failures, and the electrode failure signal 80 with no network failures extracted therefrom. In FIG. 6a, a droplet short-circuit 88 can be clearly seen at approximately 15 ms which shows no phase correlation and occurs only once. Furthermore, overlapped harmonic oscillations can be observed in the electrode signal 82 which are extracted in the electrode signal 80 with no network failures. In this regard, FIG. 6b shows the identified network failure signal 84, in which the phase-correlated failure fractions, in particular harmonic multiples of the period duration of the network, can be clearly identified. The network failure signal 84 is provided at the output of the demultiplexer unit 68, such that it can be deducted from the electrode signal 82 susceptible to failures by means of the subtraction unit 56. The resulting electrode signal 80 with no network failures is free of direct current voltages and suppresses the failure fractions which essentially occur in a phase-correlated manner and periodically and can be explained by network failures.

Static frequency filters known from the state of the art can perform only a frequency limitation of a failure signal or a relevant frequency range of the electrode signal without being able to filter out network failures within the relevant frequency range. Such regular network failures can be, for instance, switching impulses of a phase angle control or of an inverted rectifier which have a certain phase relationship to the network phase or a certain periodicity and occur regularly. For instance, in the context of a closed-loop control of an alternating current motor, a heating or lighting closed-loop control, a certain frequency relationship of switching failure signals occurs which correlate with the network period.

The invention proposes to filter out periodically occurring failures, for instance multiple overtones of the network period or other frequency-correlated failure signals which do not have a statistically arbitrary distribution. The network failure filter device can be used, for instance, in vacuum arc remelting process, an electro-slag remelting process or a comparable electric remelting process. As phase storage locations, typical low-pass filter devices, such as RC members or LR members, can be used, which make a slow fading of a sampled signal value over several periods possible. In principle, the filter can be used to filter out failure signals which occur at the same frequency as the filter trigger signal and have a sufficiently fixed phase relationship to each other. Thus, rectifier failures, phase angle controller failures or network frequency harmonics can be effectively suppressed.

In one embodiment, a signal is gained from a trigger signal which describes the current phase of the oscillation on which the trigger signal is based, for instance the network frequency. Said signal controls the multiplexer and the demultiplexer and determines which phase storage locations, that is which low pass, is active at the moment. The electrode signal which is susceptible to failures is attributed to the low pass belonging to the current phase, is sampled and temporally averaged, and, after retrieval by the demultiplexer, is deducted from the electrode signal again. Thus, a gap of failure signals which have a phase-fixed relationship to the trigger signal can be achieved, wherein statistically distributed failure signals, for instance droplet short-circuits, remain in the electrode signal.

The stabilization of the trigger can be achieved by means of, for instance, a PLL (phase-locked loop circuit) or a DLL (delay-locked loop) or a similar circuit. The phase storages have a sampling behavior, wherein the output value follows the input value with a time lag, that is not upon ad hoc changes, but upon changes occurring throughout several periods. The time lag of the low pass can be individually changed, for instance during the remelting operation, and, for instance depending on the occurrence of signals, be selected high or low. Here, for every low pass, a value can be determined which depends on the deviation of the input signal from the output signal, and this deviation can be realized by, for instance, an RMS averaging (root mean square). The low-pass behavior of each phase storage location can be based on this deviation for instance.

The time lag of every phase storage location can be newly determined in every phase cycle by taking into account the deviations of its phase neighbors and itself from the previous phase cycles by means of a time-dependent weighting function. This weighting function can in particular be time-resolving and/or frequency-resolving and result from, for instance, a Fourier transform. Furthermore, said weighting function can be self-optimizing, and is applied by the periodicity analysis unit 70 which follows the equation SH(n):=f(SH[n−j][z−i], SH[n][z−i], SH[n+j][z−i]) with n=phase storage location, z=previous phase values. Thus, the equation can take into account previous periods z as well as neighboring storage locations n. Factoring in samples of neighboring phase storage locations leads to failure signals which have a phase correlation only having a small effect. Lastly, the filter effect is reduced at locations at which phase deviations can occur. An adjustable adaptive attenuation optimally adapts itself to the characteristics of the occurring failure signal. By extracting network-based failure signals from the electrode signal, an improved closed-loop control of the electrode gap or other closed-loop control criteria for a remelting process can be achieved, which leads to an increased quality of the remelt material. The proposed invention has a small technical expense and significantly improves the remelting result, and can be used with, for instance, retrofitting existing remelting furnaces but also with new installations.

1. A device for filtering supply network failures out of an electrode signal in a metallurgical electric remelting method, in particular for the electrode gap closed-loop control of a system for closed-loop control of an electrode gap of a melting furnace, said device comprising:
at least one electrode sensor device measuring at least one of an electrode current and an electrode voltage of an electrode;
a network sensor device measuring at least one of a network current and a network voltage; and
a filter device filtering network failures of the network signal out of the electrode signal, such that an electrode signal with no network failures can be emitted.

2. The device according to claim 1, wherein the filter device includes at least one frequency filter unit frequency filtering of relevant signal ranges of at least one of the electrode signal and the network signal.

3. The device according to claim 1, wherein the filter device includes at least one adaptation unit for adapting at least one of the network signal and the electrode signal to each other and a subtraction unit subtracting adapted signals from each other.

4. The device according to claim 1, wherein the filter device includes a phase detection unit for detecting a network phase value and a storage unit storing at least one of time-discrete, phase-related samples of the electrode signal and the network signal in a plurality of phase storage locations.

5. The device according to claim 4, wherein the phase detection unit includes a network phase indentifier.

6. The device according to one of the claim 4, wherein the phase detection unit includes a multiplexer unit and a demultiplexer unit, wherein the multiplexer unit attributes at least one of a sample of the electrode signal and the network signal to a phase storage location, and the demultiplexer unit reads out a sample of a phase storage location in correct phase relationship.

7. The device according to claim 4, wherein the filter device includes a periodicity analysis unit analyzing periodic network failures in the electrode signal, wherein the periodicity analysis unit reads out, changes and stores phase-related samples stored in the phase storage locations of the storage unit.

8. The device according to claim 7, wherein the periodicity analysis unit at least one of adjustably averages an attributable sample of a phase storage location with previously stored samples of said phase storage location and to adjustably weights said sample with samples of neighboring phase storage locations.

9. The device according to claim 7, wherein the periodicity analysis unit is able to adaptably controls a switching phase interval of the multiplexer unit and the demultiplexer unit.

10. A method for filtering supply network failures out of an electrode signal in a metallurgical electric remelting method, in particular for the closed-loop control of an electrode gap, said method comprising:
measuring at least one of an electrode current and an electrode voltage of an electrode;
measuring at least one of a network current and a network voltage; and
filtering network failures of the network signal out of the electrode signal, such that an electrode signal with no network failures is emitted.

11. The method according to claim 10, wherein the electrode signal and the network signal are adapted to each other and subtracted from each other.

12. The method according to claim 10, wherein a network phase is identified on the basis of the network signal and phase-related samples of the electrode signal are stored, such that, on the basis of the electrode signal samples, periodic network failures are identified and deducted from the electrode signal.

13. The method according to claim 12, wherein the samples are at least one of averaged with preceding samples and adjustably weighted with phase-neighboring samples.

14. The method according to claim 12, wherein the phase interval of the samples is adapted corresponding to occurring signal changes.

15. The method according to claim 12, wherein the number of the samples is variably adapted to at least one of the type and extent of the network failure and the phase of the remelting process.
